(19) United States
(12) Patent Application Publication
(10) Pub. No.: US 2005/0016354 A1
(43) Pub. Date: Jan. 27, 2005

(54) Combined musical instrument stand and workstation

(76) Inventor: Kenneth Paul Kent, Reepham (GB)

Correspondence Address: FACTOR & LAKE, LTD, 1327 W. WASHINGTON BLVD., SUITE 5G/H, CHICAGO, IL, 60607, US

(21) Appl. No.: 10/275,198

(22) PCT Filed: May 3, 2001
(86) PCT No.: PCT/GB01/01945

(30) Foreign Application Priority Data
May 3, 2000 (GB) 0010723.5
Jun. 1, 2000 (GB) 0013176.3
Dec. 16, 2000 (GB) 0030825.4

(51) Int. Cl. G10D 3/00; G10G 5/00

(52) U.S. Cl. 84/327

(57) ABSTRACT

A combined stand and workstation (10) to support a stringed musical instrument such as a guitar or a banjo has an elongate receiving member (20) to support the instrument, the receiving member (20) being rotatably supported on support means (11). The support means (11) and the receiving member (20) are both adjustable in length. The receiving member (20) has supports (22, 25) for the base of the instrument and for its neck, and additionally can comprise an intermediate support to support the body of the instrument. The second instrument receiving portion (25) is rotatable and can be biased by means of a spring (27) to engage the neck of the instrument and prevent it from moving.

### FIELD OF THE INVENTION

The invention relates to a combined stringed musical instrument stand and workstation which can be used to support an instrument in a substantially upright position when the instrument is not being played and which can be adjusted to support the instrument in a horizontal orientation or an inverted vertical orientation when required.

### BACKGROUND TO THE INVENTION

Stands for stringed instruments particularly guitar-stands are well known and are widely used. They commonly comprise a frame with supporting legs on which are mounted supports for the base and neck of the guitar. The instrument is placed on the frame with the neck in a near vertical position, but tilted backwards so that gravity keeps the instrument retained on the supports. These stands are used to hold the instrument when not in use to prevent accidental mechanical damage.

However, when any work is to be carried out on the guitar such as changing strings, tuning or cleaning, it is usual to remove the guitar from the stand because the height, position and stability of the stand is not suitable for such operations. The operative holds the instrument or places it on a flat surface such as a table to carry out the work. Unfortunately, the instrument is then prone to being damaged due to accidental dropping or slipping and the operative is at a disadvantage due to having to use one hand to hold the instrument whilst carrying out the work required.

It is an object of the invention to provide a combined stringed musical instrument stand and workstation to support an instrument when it is not in use and which can be adjusted to provide a support for the instrument when work needs to be carried out on the instrument.

### SUMMARY OF THE INVENTION

According to the invention there is provided a combined stand and workstation for a guitar or other stringed instrument comprising a first instrument-receiving portion adapted to receive the body of the instrument and a second instrument-receiving portion adapted to receive or engage a neck of the instrument, one of said portions including a coupling member to which a support means is pivotally connected, the coupling member enabling an instrument to be supported in both horizontal and vertical orientations.

The first and/or second instrument-receiving portions are preferably telescopic.

The second instrument-receiving portion is preferably pivotally mounted on the first instrument-receiving portion. The second instrument-receiving portion advantageously presents a surface which frictionally engages the neck of the instrument. The second instrument-receiving portion is conveniently substantially U-shaped. Twisting of the second instrument-receiving portion about the pivot mounting engages the neck of the instrument and hinders or prevents movement of the instrument parallel to the longitudinal axis of the first instrument-receiving means.

The second instrument-receiving portion is advantageously urged into engagement with the instrument neck by a spring mechanism. A cross-piece or strap can be provided on the second instrument-receiving portion to additionally secure the instrument in position.

The stand and workstation preferably includes a base support adapted to support the base region of the instrument. The base support is conveniently adjustable to accommodate instruments of different sizes, to enable the workstation to be used for different makes and types of instrument. The base support preferably presents a surface which frictionally engages the base of an instrument to reduce movement of the instrument when the stand and workstation is in use.

The stand and workstation preferably includes a mounting plate, onto which the base support is slideably and pivotally mounted.

The base support advantageously comprises two tubular members, so formed to engage and support an instrument. Each tubular member is preferably independently releasably slideable and pivotally mounted with respect to the first instrument receiving portion, to facilitate the support of different instruments.

The first support member is preferably pivotally mounted about its longitudinal axis to enable the instrument to be effectively held on its side, to enable the operative to more easily access the side of the instrument.

The stand and workstation advantageously comprises a further support member located between the second instrument-receiving portion and the base support to provide additional support for the instrument.

According to a further embodiment of the present invention there is provided a combined stringed instrument stand and workstation which is adjustable in height and angle of support and position, comprising a base unit on legs, a height adjustable main upright frame, a pivoted support frame assembly for an instrument which can be rotated and releasably secured to allow the instrument to be positioned at an adjustable angle including the horizontal position, means for adjusting and releasably securing the height of the instrument support frame assembly, means for rotating the instrument support frame assembly about the axis of the main upright frame and releasably securing it, a spring loaded mechanism to grip the neck of the instrument which is mounted on an adjustable length neck support arm on the instrument support frame assembly which can be releasably secured.

### BRIEF DESCRIPTION OF THE DRAWINGS

One embodiment of the present invention will now be described by way of example only with reference to the accompanying drawings in which:

FIG. 1 shows in perspective, a first embodiment of a guitar-stand in the normal support stand position with the second instrument-receiving portion arm extended; and

FIG. 2 is a further perspective view of a guitar-stand with the guitar support frame assembly rotated to a horizontal position;

FIG. 3 is a front view of a support arm adjuster;

FIGS. 4a and 4b are, respectively a front view and a side view of a mounting plate of the support arm adjuster shown in FIG. 3;

FIGS. 5a to 5d are respectively, a side view and a front view of a support arm and, a front view and a side view of a second support arm;

FIG. 6 shows in perspective a second embodiment of a guitar stand and workstation in the normal support position;

FIG. 7 shows a further perspective view of the guitar stand and workstation of FIG. 6 with the guitar support frame assembly rotated to a horizontal position; and

FIG. 8 is a diagram of a pivot member which enables the guitar support frame to pivot about a second axis.

### DETAILED DESCRIPTION OF THE INVENTION

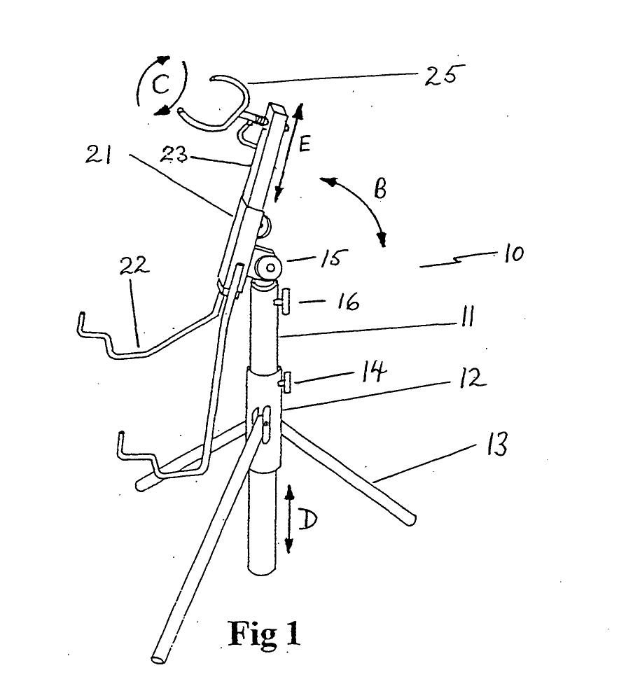

Referring initially to FIG. 1, the stand 10 has a central tubular support member 11. A tubular collar 12 is slidably mounted about the central support member 11. Further support for the stand 10 is provided by three legs 13, the legs 13 being pivotally mounted at one end to the collar 12. Once the angle of the legs has been established, relative to the central support member 11 which gives maximum stability to the stand 10, the legs 13 can be fixed in position by locking means (not illustrated). The position of the collar 12 on the central support member 11 is secured by engagement of the locking member 14 against the central support member 11.

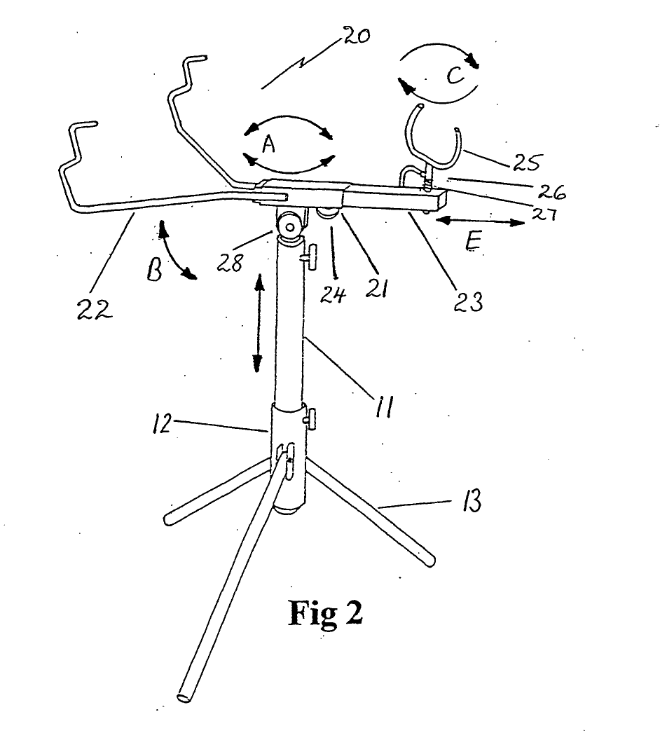

A connection joint 15 is rotatably mounted to the upper end of the central support member 11, rotation being as indicated by arrows A in FIG. 2. A further locking member 16 fixes the connection joint 15 in its desired position. An instrument support frame generally referenced 20 is rotatably mounted to the connection joint 15. The direction of rotation of the instrument support frame 20 being indicated by arrow B in FIG. 1. By means of the connection joint 15, the support frame 20 can be so orientated to support an instrument in an upright, horizontal, inverted vertical position, or a position therebetween. The instrument support frame 20 comprises a tubular primary support element 21 having a substantially square cross section. Two instrument-base support arms 22 are fixed to one end of the primary support element 21. A second instrument-receiving portion arm 23 is slideably housed at a first end within the primary support element 21 to give an instrument support frame 20 of the desired length. The overall length of the instrument support frame 20 can be fixed by means of the locking member 24 which acts to hold the second instrument-receiving portion arm 23 in position.

A neck grip 25 is mounted at a second end of the second instrument-receiving portion arm 23. The neck grip 25 is substantially U-shaped and engages and supports the neck of the instrument. The neck grip 25 is rotatably mounted about pivot 26, rotation being in the direction indicated by the arrow C.

A spring 27 urges the neck grip 25 to rotate in order to grip the neck of the instrument. The amount of rotation is governed by the width of the neck of the instrument being supported. Furthermore, the U-shape of the neck grip 25 enables it to grip the neck of an instrument more efficiently.

The surfaces of the instrument-base support arms 22 and neck grip 25 are covered with a soft material such as a rubber, plastics or similar material in order to prevent damage to the instrument. The material used can also increase the frictional force between the instrument-base support arms 22 and the neck grip 25 and the instrument in order to retard movement of the instrument.

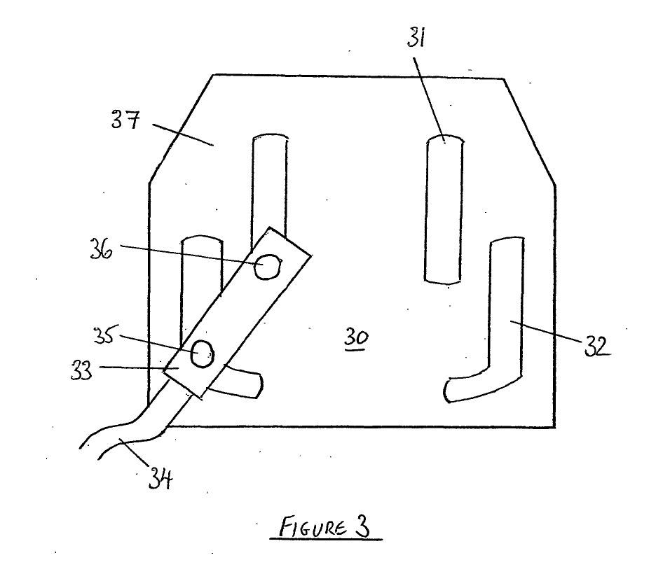

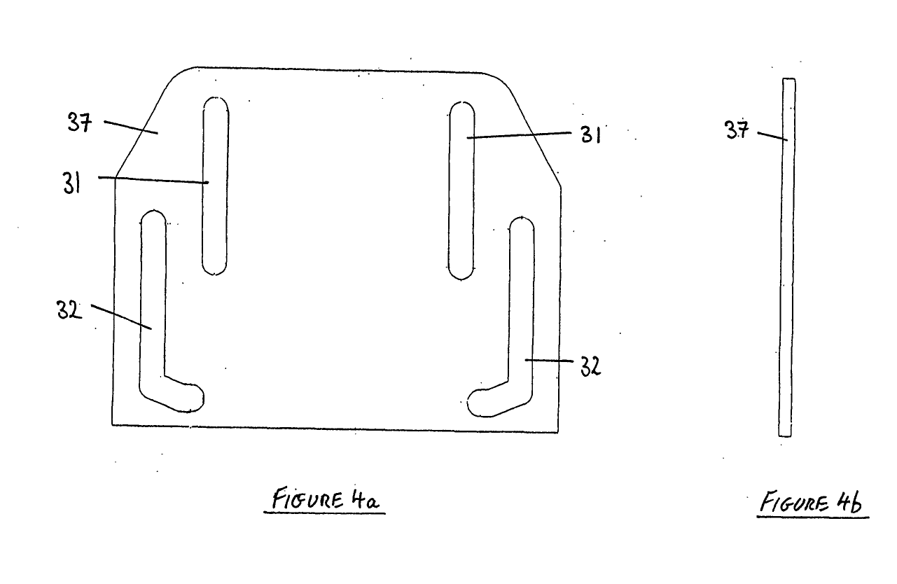

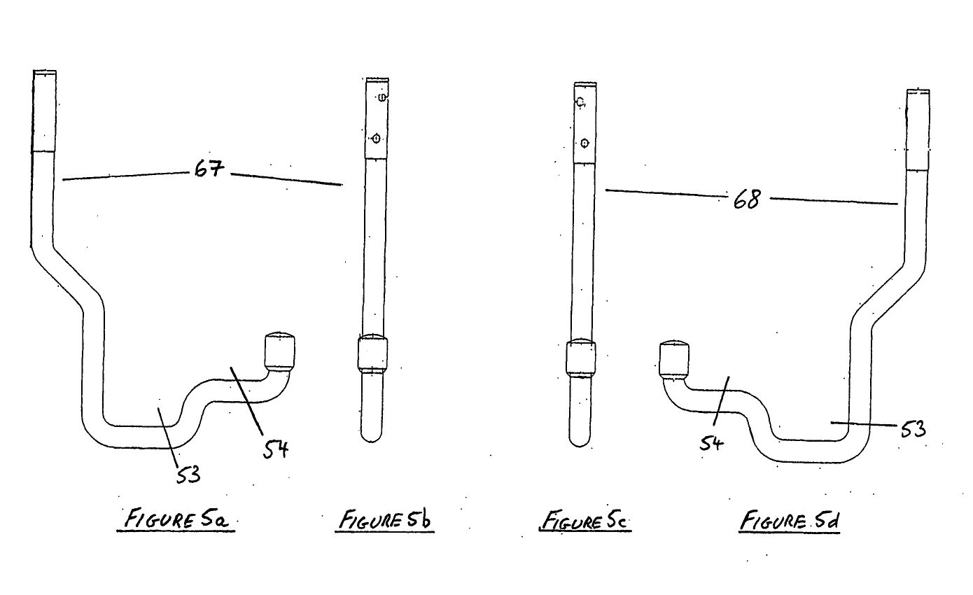

In FIGS. 3 and 4a, b a support-arm adjuster 30 is shown. The adjuster 30 has a mounting plate 37, the mounting plate 37 having two substantially rectangular slots 31 and two “L” shaped slots 32, arranged in pairs to either side of the adjuster 30. A mounting-tube 33, to which a support-arm 34 is mounted has two holes (51, 52 of FIGS. 5b, 5c) within its body. A first rod 35 passes through one of the holes and through slot 31, and a second rod 36 passes through the other hole and then through the slot 32. The rods 35, 36 are broadened at a first end to prevent the rods 35, 36 from falling out of the holes. The rod 35 is also broadened at its second end to secure the rod 35 in position whilst still allowing rotation of the rod 35. The rod 36 has a threaded second end to receive a wing-nut (not illustrated) which on tightening secures and maintains the mounting-tube 33 in position. A base support-arm is similarly mounted to the other two slots as shown in FIG. 3.

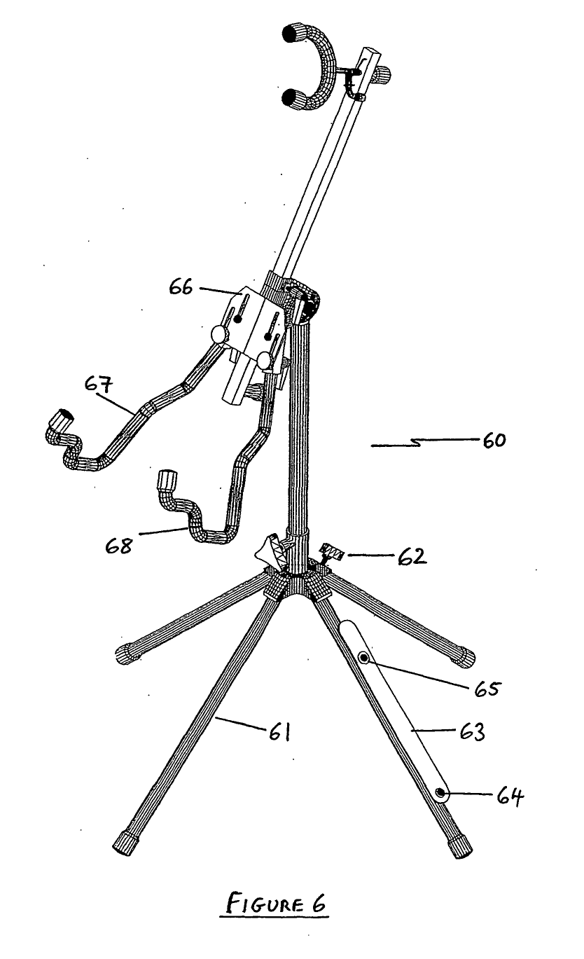

FIGS. 5a and 5d show, respectively the curvature of the support arms 67 and 68 of FIG. 6 of FIG. 3. The wells 53, 54 within the upturned portion of the support arm 67, enable guitars and other instruments of different sizes to be supported on the support arms 67, 68, without imparting stress to the body of the instrument.

FIG. 6 illustrates a guitar stand and workstation 60 having a number of features in common with the stand and workstation 10 shown in FIG. 1. The stand and workstation 60 however, differs from the stand and workstation 10 in a number of respects. The stand 60 has four legs 61, which give the stand 60 greater stability when supporting an instrument. One of the legs 61 is telescopically adjustable in length to enable the stand 60 to be used on uneven surfaces. The length of the adjustable leg 61 is releasably fixable by means of a knob 62. A strap 63, releasably mounted to one of the legs 61 at 64, 65 is included. With the stand 60 in a folded configuration ready for storage or transportation, the strap 63 retains the legs 61 in said folded position, by wrapping around the stand 60.

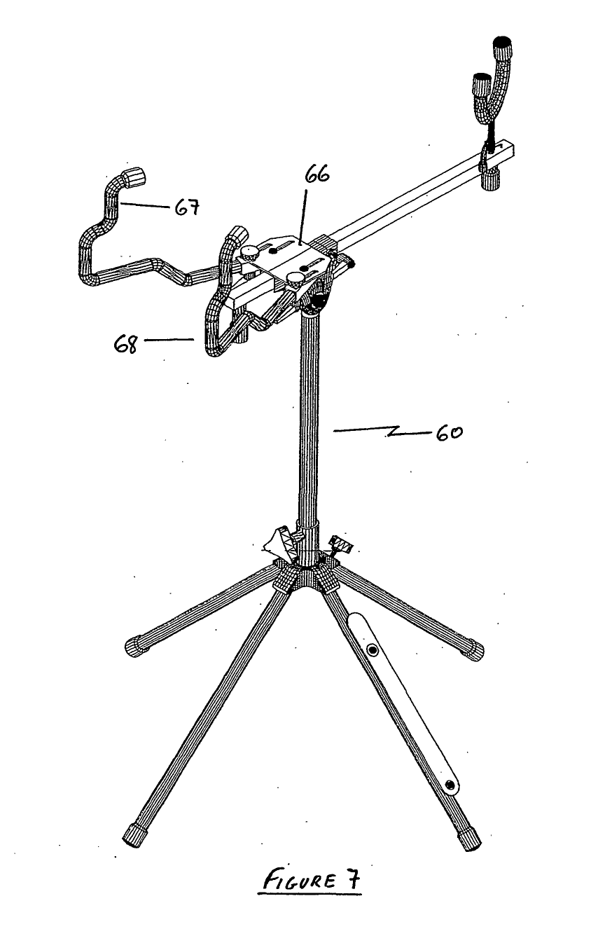

The stand 60 further includes a mounting plate 66 and support arms 67, 68 as described in FIGS. 3 to 5. The angle between the support arms 67, 68 can therefore be adjusted to more suitably support the particular instrument on which work is being carried out. As shown in FIG. 7, the stand 60 can be adjusted to support an instrument in a horizontal position.

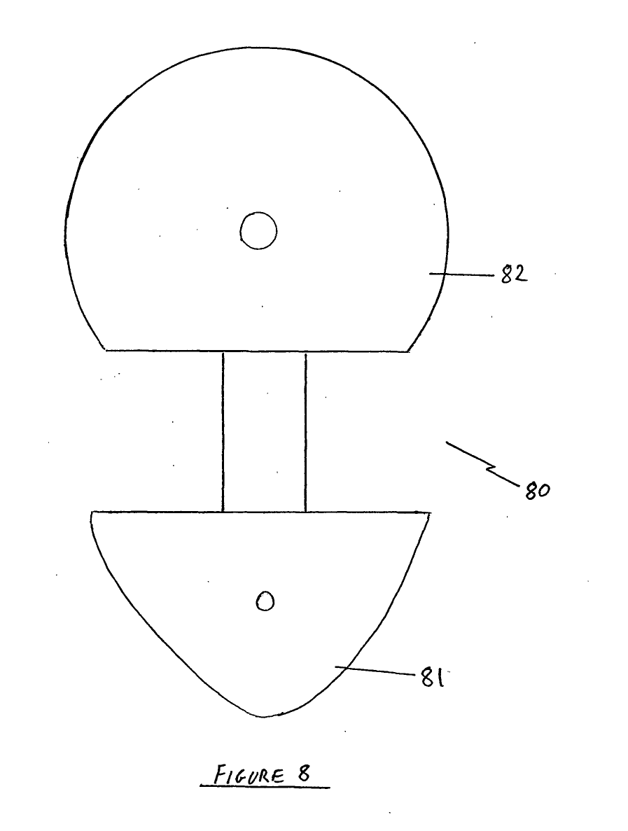

The pivot member 80, shown in FIG. 8, can be fitted—with reference to FIG. 1—between the support member 11 and the connection joint 15 the bracket 81 fitting over or around the connecting joint 15. The primary support element is mounted on to the support 82, enabling the primary support element to rotate about the axis of the support 82. The pivot member 80 in conjunction with the connection joint 15 enables the primary support element 21 to be rotated in two planes. In use, the pivot member 80 enables the instrument to be turned and held in position on its side. This has the dual advantages of firstly enabling the instrument to be tuned more precisely. Secondly, it gives access to electronic components, which on some instruments are located on the side of the instrument.

By means of the above adjuster therefore, the relative heights of the base support-arms can be releasably adjusted, to enable the apparatus to support both left—and right-handed guitars having an asymmetric base.

In use, to support an instrument, the height of the stand 10 is adjusted, in a direction indicated by arrow D, by sliding the central support member 11 within the tube 12 until the required height is achieved. The height of the stand 10 is fixed by use of the locking member 14. The legs 13 of the stand 10 are rotated and fixed in their required position. The angle of the instrument support frame 20 is suitably adjusted by rotation about connection joint 15 and fixed into position by locking member 28. The length of the instrument support frame 20 is adjusted by sliding the second instrument-receiving portion arm 23 in the direction indicated by arrow E until the instrument support frame 20 is of a suitable length to support the instrument. The instrument is then positioned onto the stand by placing the base of the instrument in contact with the base support arms 22. The neck grip 25 is rotated to accommodate the neck of the instrument, and once the instrument has been accommodated the spring 27 biases the neck grip 25 to rotate and grip the neck of the instrument.

The instrument support frame 20 can be adjusted to serve as a workstation, when repairs need to be made, quickly and easily even when an instrument is being supported. With the instrument positioned and secured on the stand 10 as described above, the locking member 28 is released and the instrument support frame 20 rotated about connection joint 15. When the instrument has been rotated so that it is substantially horizontal, the locking member 28 is tightened to maintain this position.

Once work has been carried out on the instrument, it can be returned to a substantially upright position by reversal of this procedure. Where necessary during work on the instrument, release of locking member 16 allows the instrument to be rotated and fixed into a new position so that the operator can more easily access different parts of the instrument.

The locking members 14, 16, 24 and 28 can be a bolt, clamp or similar means.

The stand 10 may additionally comprise a further support member (not illustrated) to support the instrument mid-way along its length when the instrument is in a horizontal position. Such a further support member may be supported for example on the primary support element 21. Such an additional support will prevent bowing of the instrument neck which is not only damaging but can also, by altering the longitudinal length of the instrument, give the operator a misleading idea of the string tension adjustment required to achieve a certain pitch.

The stand 10 can also be provided with a strap or other cross-piece across the open end of the neck grip 25, the strap or cross-piece acting primarily to prevent the instrument from falling out should the stand 10 be tipped over. The cross-piece or strap can also tightly grip the neck of the instrument to prevent its movement when work is being carried out.

The stand 10 can also be provided with a further strap or cross-piece to grip the main body of the guitar, principally about the junction of the main body and the neck of the guitar. Such a grip should hold the guitar firmly and support the guitar even when the guitar is rotated in an upside-down position, such that the weight is no longer supported by the support arms.

The grip is particularly useful when the operator wishes to work on the back of the main body of the guitar, enabling the back of the guitar to be held in a convenient position for access. When using such a grip, a stand having four legs will typically be used as the guitar can then pass between two of the legs, and the stands remain stable.

Without being limiting, the support stand as described above can be used to support instruments such as a guitar, banjo, bass guitar etc. It may also be used for instruments having more than one neck. A stand may also be contemplated for use as a table-top work-station, the stand having shorter legs than those illustrated herein.

Because of the rotatable nature of the legs 13 and the instrument support frame 20 the stand may be easily folded away to aid transportation. To facilitate this, securing means can be incorporated to maintain the legs in a parallel position to the central support member 11. The instrument support frame 20 can also be fully removable from the rest of the instrument stand. As an alternative to the pivot mountings described above, ball joints or similar mountings enabling the constituent parts to rotate or pivot can also be included.

It will of course be understood that the invention is not limited to the specific details described herein, which are given by way of example only, and that various modifications and alterations are possible within the scope of the invention.

1. A stand (10) for a guitar or other stringed instrument comprising a first instrument-receiving portion (21) adapted to receive the body of the instrument and a second instrument-receiving portion (25) adapted to receive or engage a neck of the instrument, one of said portions including a coupling member (15) to which a support means is pivotally connected, the coupling member enabling an instrument to be supported in both horizontal and vertical orientations.

2. A stand (10) according to claim 1, wherein the length of the first instrument-receiving portion (21) is telescopically adjustable.

3. A stand (10) according to claim 1 or claim 2, wherein the length of the second instrument-receiving portion (25) is telescopically adjustable.

4. A stand (10) according to any preceding claim, wherein the second instrument-receiving portion (25) is pivotally mounted onto the first instrument-receiving portion (21).

5. A stand (10) according to any preceding claim, wherein the surface of the second instrument-receiving portion (25) frictionally engages the neck of an instrument.

6. A stand (10) according to any preceding claim, wherein the second instrument-receiving portion (25) is substantially U-shaped.

7. A stand (10) according to any of claims 4 to 6, wherein the second instrument-receiving portion (25) is urged into engagement with the instrument neck by a spring mechanism.

8. A stand (10) according to any preceding claim, wherein the stand has a cross-piece or strap support to additionally secure the instrument in position.

9. A stand (10) according to any preceding claim, wherein the stand (10) includes a base support (22) adapted to support the base region of the instrument.

10. A stand (10) according to claim 9, wherein the base support (22) is adjustable to accommodate instruments of different sizes.

11. A stand (10) according to either of claims 9 or 10, wherein the base support (22) presents a surface which frictionally engages the base of an instrument.

12. A stand (10) according to any one of claims 9 to 11, wherein the stand (10) includes a mounting plate (37), onto which the base support (22) is slideably and pivotally mounted.

13. A stand (10) according to any of claims 9 to 12, wherein the base support (22) comprises two tubular members (34), so formed to engage and support an instrument.

14. A stand (10) according to claim 13, wherein each tubular member (34) is independently slideably and pivotally mounted with respect to the first instrument receiving portion (21).

15. A stand (10) according to any preceding claim, wherein the first support member (21) is pivotally mounted about its longitudinal axis to enable the instrument to be effectively held on its side.

16. A stand (10) according to any preceding claim, wherein the stand (10) comprises a further support member located between the second instrument-receiving portion (25) and the instrument-base support (22) to provide additional support for the instrument.

17. A combined instrument stand and workstation (10) which is adjustable in height and angle of support and position, comprising a base unit on legs (13), a height adjustable main upright frame (11), a pivoted support frame assembly (21) for an instrument which can be rotated and releasably secured to allow the instrument to be positioned at an adjustable angle including the horizontal position, means for adjusting and releasably securing the height of the instrument support frame assembly (14), means for rotating the instrument support frame assembly (21) about the axis of the main upright frame and releasably securing it, a spring loaded mechanism to grip the neck of the instrument which is mounted on an adjustable length neck support arm (25) on the instrument support frame assembly which can be releasably secured.

18. A stand (10) substantially as herein described with reference to and as illustrated in the accompanying drawings.
